(19) United States
(12) Patent Application Publication
(10) Pub. No.: US 2003/0231459 A1
(43) Pub. Date: Dec. 18, 2003

(54) Ion chip composite emitter

(76) Inventor: Reginald R. Robertson, Winnipeg (CA)

Correspondence Address: R R ROBERTSON, APT 201 605 RIVER AVE, WINNIPEG, MB, R3L OE7, CA

(21) Appl. No.: 09/983,784

(22) Filed: Oct. 25, 2001

(51) Int. Cl. H01G 4/38

(52) U.S. Cl. 361/330

(57) ABSTRACT

My present Ion Chip Composite Emitter Invention was developed specifically to overcome problems experienced of an operational and maintenance nature of prior designs. And relates to the inherently stable ionising capability of a three layered robust construction connected to a regulated High Voltage power source. To provide highly directional reliable strongly focused, predictable modularly adjustable streams of small active negative air ions with only trace ozone entrained. To be safely and strategically injected into the ambient air and ion multiplying ventilation air flows of an enclosed, occupied, prospectively hazardous environment. Providing the control and precipitation of harmful air borne contaminants and remedying deficiencies of Electrical Air Quality of unacceptable levels of positive air ion imbalance. A specific Embodiment is the construction of Operating Modules to contain fully protect and ambush individual ionising filaments subsequently assembled to provide the Composite Emitter with the desired output characteristics. With the further aspect that in recognition of the inevitable electrode erosion, each filament, Module, or the entire single or double sided composite emitter can be simply and economically replaced to maintain performance. A further aspect is that an additional Higher Voltage supply will provide greater focus and protection of emissions from weakening and distortion by grounded structures to improve emitter performance. The arrangement providing an option for a calculated intermittent entrainment of ozone for periodic fumigation applications when a high concentration of air borne pathogenic microbes is anticipated in the environment. The aforementioned embodiments and associated aspects of the Invention incorporated in the design of a self contained Ionising Fixture requiring a simple standard 110 Volt A:C installation acceptable in Industrial Commercial, Institutional, Medical and Residential Establishments.

### THE ORIGIN OF THE INVENTION

The origin of the Technology and Invention is the pursuit of a hypothesis that duplicating the massive natural occurrence of a lighting thunderstorm in the Countryside in a practical miniature, safe, environmentally acceptable manner within an enclosed building air plenum will produce the same result of cleaner and fresher air.

### PURPOSE OF THE INVENTION

The purpose of the Invention is to advance the systemic application of Negative Ionisation and Allied Techniques to improve Air Quality within virtually any enclosed Air Plenum with intrinsic safety and within EDA guidelines of ozone entrainment. Accepting such basic supply restrictions directed attention to the upgrading the weakest link of this “Technology for our Time” identified in the course of R&D as the crude easily damaged nature of early questionable low output emitters where experimentation showed that a totally new design approach was required in the interest of operating performance safety and maintenance. To have the capability to cope with varying degrees and types of pollution in a systemic manner. Achieving in the process of Development a low cost well engineered aesthetically acceptable simply maintained system comparable to a lighting installation.

### The Problem of Indoor Air Quality and the Solution

The problems of Indoor Air Quality are a product of our lndustrialised Modern Society ascerbated by Energy Conservation practices which has trended to minimise ventilation air changes and make up air requirements. In conjunction with developments in Building Construction, where the criteria has been to minimise heat and cooling losses, by high insulation factors and with maximum sealing to prevent outside air infiltration. With excellent results in terms of energy savings and conventional Indoor Air Quality standards of creature comfort. But unfortunately has excluded any determination of “Electrical Air Quality”. Specifically with regard to a desirable natural balance of beneficial negative air ions to polluting positive ions. A dimension largely ignored and dismissed except by enlightened HVAC specialists now prepared to incorporate the Systemic Application of Negative Ionisation acting in complete harmony with their current designs providing negative ion enriched ventilation airflows to optimise air cleaning and freshening performance. The systems having demonstrably achieved the earliest precipitation of air borne contaminants to the ground “out of harms way” for subsequent removal by routine housekeeping. In the process, dynamically remedying deficiencies in the Electrical Quality or freshness of the air, requiring only minuscule additional energy consumption. In a truly unique completely natural static benign manner, neither technically nor economically possible by any other means.

### Market Prospects for a Natural Solution to a Global Problem

In pursuing the Hypothesis of duplicating Nature by the systemic application and injection of ionised streams gaseous Negative Air Ions to improve Indoor Air Quality it became evident that this was a “Technology for our Time” with the realisation perhaps belatedly by our energy conscious Industrialised Society that besides the well publicised deterioration of our Global Environment, changing lifestyles had also created problems with Indoor Air pollution in virtually all spheres of our activities necessarily carried out in an enclosed ventilated environment. But whereas the solution to the deterioration of our Global Environment is highly politicised, monumental in scale, requiring trillion dollar costs and unlikely to be fully resolved in our lifetime. In comparison there is considerable hard evidence based upon the success of embryonic prototype air ionisation systems that a unique solution can now be provided, which can be purchased on an individual basis. The solution evaluated and verified by arms length in-house Statistical Process Control having low installed and running cost, requiring minimal energy consumption. Providing a Return on Investment, of considerably less than one year in most cases through increased Productivity, Product Quality, and higher standards of Workplace Health and Safety. The track record of successful prototype development primarily using only the minimum application of the Technology to act with the static ventilation air include:

Installations to control static and air borne dust by precipitation during Manufacturing Finishing Operations in the Hygiene Paper Industry, the Plastic Industry, The Automotive Industry, Suppliers to the Automotive Industry, the Photographic Industry and the Glass Industry where rejection levels due to inclusions in the products were significantly reduced as determined by in house Statistical Process Control. Installations to control air borne contamination which is known to be a combination of fine dust particles and harmful bacteria for the Food Preparation, Packaging Industry, and the Confinement Rearing and Care of Livestock (pigs, poultry, pigeons and horses.) With the successes in this instance including a significant reduction in antibiotics fed to the livestock for weight gain and shorter production cycles. Installations for Dental and Medical institutions to combat infection caused by the air borne transmittal of harmful pathogenic microbes increasingly resistant to antibiotics.

Installations for Administration Offices, Supervisory Stations, Transportation Facilities and other heavily staffed and occupied areas where computers as a source of positive air ion emissions can contribute to the problem of sub standard Indoor Air Quality.

Installations for Restaurants, Bars, Fast Food Outlets to reduce the harmful effects of Tobacco Smoking and the spread of infection for the benefit of patrons and staff.

A major factor for the advance of the Technology is the performance of the Composite Ion Chip Emitter Invention with the capability to both act and interact in harmony with the existing ventilation air treatment facilities of the particular establishment.

### FIELD OF THE INVENTION

The electronically high voltage supplied Composite Emitter invention comprises a simple highly effective adaptable modular robust construction superior in all respects to prior designs. With both inherent and enhanced reflecting electro-static field capabilities to be strategically mounted at or near ceiling height for the purpose of creating a system of highly directional high volume focused streams of negative air ions to be introduced directly into the static ambient air. Or combined as necessary with air ion multiplying existing ventilation airflows of an enclosed environment to improve air quality.

So that with the natural propensity of negative air ions to seek ground potential the systems will provide:

A variable intensity strategically located distributed Negative Ion “Shower”

A variable concentrated dividing “Curtain” of Negative Ions

A variable entrainment of Negative Ions in existing ventilation air flows.

With the objective to obtain the scientifically accepted beneficial characteristics of Negative Air Ions to improve Indoor Air Quality with respect to:

Dispersal of Electro static

Accelerated precipitation of air borne contaminants.

Growth inhibition of certain pathogenic microbes and bacteria,

Optimisation of Neg/Pos ion presence. (Ion Effect)

The high performance capabilities of the Invention have significantly advanced the systemic applications of Negative Ionisation Technology of particular note, is the upgrading of Engineering and Aesthetic Standard of the Installations now fully acceptably in any situation or location where there is a problem of Indoor Air Quality. The field of the invention is not confined to the Systemic Applications as described to achieve customer-verified Statistical Process Control increases in Workplace Productivity and Higher Standard of Health and Safety. But can be employed in any application requiring the safe environmentally acceptable high stable output of air ions of either polarity for any device. Including an option for the selective intermittent controlled introduction of ozone for periodic fumigation to improve the performance of a specific type of system to periodically strongly inhibit the growth and spread of air borne pathogenic microbes. All equipment easily manufactured from currently available materials employing existing production methods and currently installed as a retro-fit addition which is in full Compliance with regulatory requirements of ozone restriction and Safety of Operation in Canada, USA and Europe. With a further prospect that the invention can be made integral with conventional HVAC air handling equipment.

### Competitive Methodology

The most common method to apply negative ionisation as a means of improving air quality in relatively small areas is with self contained units Comprising; an inlet air filter, a small variable speed fan, an electronic High Voltage Ion generator connected internally to some form of emitter,—usually carbon fibre strands or sharp profiled ionising needles—to create negative air ions by electrical stress corona. In operation air is pulled in from the ambient surroundings, which after relatively coarse filtering, passes over the emitter arrangement to create negative air ions which are then dispersed by the fan into the area to be treated.

This approach has achieved qualified success with the main drawbacks being the build up of fine dust in the unit requiring considerable maintenance and reducing output due to dust build up from the ambient air. The ozone level can exceed FDA requirements, a matter of some debate for Health reasons. Major reservations on the effectiveness of air ion distribution by the fan. Finally the fan noise is considered objectionable in many applications.

### Systemic Application Versus Fan Assisted Air Ion Dispersal

The systemic application concept is that instead of having the ion Generator housed with the fan and filter as a complete assembly. A series of Ion Generators can supply a series of emitters installed at ceiling height and in the path of incoming air flows. As a consequence, the build up of dust which occurs even with the most efficient filter with a combined arrangement is absent. No fan is required, reducing electrical consumption and the operation is completely static and silent. Also as further described the systemic approach allows that the corrective influence of Negative Ionisation can be applied in the correct strengths, from the most advantageous positions, at the correct time, to allow for periodic surges in pollution creating activities to act in harmony with existing air treatment facilities to optimise the benefits of both technologies within a particular enclosed environment.

### Systemic Application of Negative Air Ions within an Enclosed Air Plenum

The essential advantage of the systemic application is its flexibility and effectiveness with minuscule energy consumption requirements to custom design a static installation for any enclosed environment, always acting on the premise that the basic ventilation and air treatment facility is fundamentally sound in the first instance with low velocity and substantially laminar airflows. And after confirmation as regards the type, source and extent of the problem of air quality to be remedied. Based on this knowledge a determination can be made how the negative ions provided by the Invention should be introduced into the air plenum to control and cause the earliest settlement of air borne contaminants and achieve the beneficial Ion Effect with a continuing favourable dynamic balance of negative to positive air ions.

### Regulatory Requirements

The invention requires the Composite Emitter to be connected to a negative uni-polar limited High Voltage threshold and limited low short circuit capacity electronic power source. To ensure that operationally even under fault, only “Cold Sparking” Minimum Ignition Energy (MIE) can occur. With an ozone ion entrainment well within the USA Environmental Development Agency (EDA) recommendation of less that 50 parts per billion. The installations will conform to the 1991 Revision of the Canadian Electrical Building Code for High Voltage Extremely Low Power circuits with equipment which is approved by the Canadian Standards Association (CSA). So that the systems can be installed in all but the most extreme hazardous environment specifically when the Composite Emitter forms part of an integrated Ionising Fixture with all High Voltage connections made internally, requiring only a 110 Volt installation.

### Passive Mode

The passive mode of operation is where emitters are positioned at a ceiling height, usually between 8 ft to 10 ft above the area(s) identified by observation to be the main source(s) of pollution in such a manner that the negative ions en-route to the ground will intercept and precipitate air borne contaminants almost immediately to contain spread. It is also feasible to employ a pattern of both negative and positive ions to change the settlement of air borne contaminants directionally away from or towards a specific area. Closely spaced parallel lines of emitters can be used which will act as a concentrated ion curtain barrier to prevent the passage of air borne contaminants between areas where any form of permeable barrier screen would not be permissible.

### Interactive Mode

This “go with the flow” interactive mode of operation is to have emitters inject negative ions into the existing ventilation distribution and diffuser arrangements. The flow of air has a multiplier effect on emitter static output with the further advantage that the negative ion enrichment and dispersal is in accordance with the designed ventilation air flows providing a dynamic feature to exploit the technology in harmony with existing air treatment facilities to obtain and maintain a restoration of negative air ion depletion and the beneficial Ion Effect.

### Modulation Mode

The Modulation Mode of Operation is the introduction of low pressure fan air or compressed instrument type air or other gas aerosol mixture to interact with the flow of negative air ions from the emitter for the purposes of:

Blow-down to clean the emitter

Periodic increased Ion Flow

Accelerated anti-bacterial action

Strengthen air ion curtain barriers

### Sweep Mode

The sweep mode of operation requires emitters of an appropriate dome or pyramid design to be rotated at some low variable RPM or oscillated to impart a strengthened dynamic to a fixed, static emission distribution. The arrangement can also provide the means to wipe clean the ionising filament where pollution is particularly heavy.

### Ionising Tube

A series of ring modules inside an insulated Ventilation Tube and another at the exit end will provide a high density negative ion enriched air flow. To act as a blow-off device or a specific injection of air ions into an air plenum for a localised quality problem.

### Ion Wash/Ion Shower System

This system is employed at a Finishing Operation where dust, dirt or other contaminants are blown off a product (Ion Wash) and after removal almost immediately precipitated to prevent further migration (Ion Shower). An arrangement a few feet in length which proved highly successful to replace long “Clean Tunnel” installations previously used to reduce inclusions at Automotive Paint and Coating Plants in North America at a fraction of the cost. The extent of the pay-back obviously considerable was not divulged. However FIG. 16 Statistical Process Control (SPC) data shows the effectiveness of this type of installation using an earlier improved design of emitter now made obsolete by the invention.

### The Dynamic Negative Ionisation Conditioning of an Air Plenum Disclaimer Conditions

Conventional Installations—A negative ionisation system is designed as a unique addition to improve the performance of existing ventilation and air treatment systems by the control of electro static and the precipitation of extremely small airborne contaminants, in the process, achieving a more favourable mix of negative to positive ions considered beneficial to the occupants of the particular environment. Known as “The Ion Effect”

It is not a panacea which will compensate for initial faulty designs or cope with extremely heavy dusty conditions which rightly should be handled by a correctly designed conventional ventilation facility. Also as a dust settlement process only normal low laminar flow velocity air changes can be tolerated within the air plenum requiring conventional air lock precautions on occasions.

Clean Room Protocol—The anticipated performance of any negative ionisation system will only be achieved industrially when operatives and management adopt normally expected clean room protocol for mutual benefit of increased Productivity and Health and Safety in the Workplace.

### Purge Period

Typically, before a negative ionisation system is first energised, or before being re-energised after a shut down, there will be a high concentration of suspended particles in the air plenum where their presence and random settlement can cause problems.

This accumulation is complex in nature and difficult to predict beforehand as it involves the volumes, type and size of particles being generated by work-in-process, human or animal activity. Also the ambient air conditions of temperature and humidity, some normal gravitational settlement and dilution by existing low velocity ventilation extraction and airflows require consideration.

In certain situations the morphology of the airborne particles and behaviour according to Stokes Law can mean virtually permanent suspension and slow migration. A situation which has been observed in certain areas in Hospitals, Aircraft and Livestock Barns where suspended pathogenic microbes have been detected in the air creating an airborne minefield of infection increasingly resistant to antibiotics.

It may take between 24 hours and 48 hours depending on the accumulation of airborne pollutants and the strength and distribution of negative ionisation provided by the system, to complete the purge period.

### “Appropriate Level” of Negative Ionisation

After the purge period with the accumulation of particles dispersed and precipitated, the demands on the system will be reduced so that without this absorption there should be an “appropriate level” of negative ionisation which must be constantly maintained in order that:

Airborne pollutants being generated by work-in-progress or human/animal activities will be precipitated almost immediately out of harms way.

Pollutants precipitated will be rendered immobile without the possibility of becoming airborne as long as the system remains energised. Allowing collection by routine housekeeping.

With certain bacteria and pathogenic microbes not rendered harmless as precipitated, the process of growth inhibition will continue with the precipitated residue.

Allowing for “losses” or absorption of negative ions the objective is to have a constant presence of negative ions which will produce the “Ion Effect” beneficial to the occupants of the treated environment. Known to reduce tiredness, and assist concentration with routine but critical tasks. No limit need be placed on the enrichment of Negative Ions which in contrast to the polluting effect of positive ions has proved to be entirely beneficial.

### SUMMARY OF THE INVENTION

My Ion Chip Invention relates specifically to the Development of a unique ionising Composite Emitter which has successfully overcome problems of an Operational and Maintenance nature of prior designs for the Systemic Application of Negative Ionisation to improve Indoor Air Quality by the control and earliest induced precipitation of air borne contaminants and to remedy deficiencies of Electrical Air Quality of polluting positive air ion imbalance in an enclosed, occupied prospectively hazardous environment.

Requiring Specifically for such application that ionising filaments are connected to a uni-polar negative Ion Generator designed so that only an acceptable EDA level of ozone of less than 50 parts per billion is entrained with the ions. While under fault conditions only a safe Minimum Ignition Energy Cold Sparking can occur.

The Core Aspect of the Invention relates to the disclosure of the inherent ionising capabilities of a robust three layered laminate. Comprising an insulation base with a highly conductivity deposition on its top surface With ionising filaments of carbon fibre yarn affixed to this intermediate layer having their electrodes exposed to the ambient air.

The actions of the Conductivity Layer when connected to the High Voltage Ion Generator is pivotal to the Invention by triggering and maintaining the emission of air ions in accordance with the electrode forming and erosion characteristics of the Filament.

The layer also providing a repulsing electro-static field to enhance the focus of the highly directional emissions radiating essentially perpendicularly to the insulation base until the source of corona stressing electrodes is exhausted.

A further Embodiment relates to the concept and use of Operating Modules formed by insulation guide strips support tubes or rings to act as segregating barriers to contain, fully protect and ambush each filament from its neighbour.

With the Separating barriers affixed directly on top of the Metallic Deposition each Module will produce emissions independent from any neighbour from a common operating supply. Barriers affixed directly to the top of the insulation base allows each filament be separately supplied.

Each Module independently producing negative air ions in accordance with the Core Invention and to the extent determined by the operating electrodes of the filaments contained within its boundaries.

An aspect of this construction is the capability to replace filaments or modules to maintain the output of the Composite Emitter deteriorated by the inevitable electrode erosion of the ionising process.

A further aspect to allow for electrode erosion is that the Composite Emitters are made double sided. One side unconnected and kept in reserve and brought into action when required. At which time there is the option, replace filaments or Modules or the entire Composite Emitter as a throw away item.

9. Adopt standardisation of ion output capabilities and system performance.

10. Produce a robust aesthetically pleasing easily maintained system.

11. Extend applications to in-line mechanical filters

12. Water treatment applications.

### Operating Power Supply

The electronic Ion Generator was the subject of reverse engineering to have a standard High Voltage supply for all future development to be in full Compliance with the regulatory requirements and constructed as a printed circuit board housed in a strong insulated box. The output being uni-polar negative, full wave rectification and the miniature step-up instrument transformer selected on the basis of limited short circuit capacity to ensure Minimum Ignition Energy “Cold Sparking” under fault and limited threshold DC value of about 7.0 kV to ensure limited ozone, considerably within the EDA recommendation of 50 parts per billion.

### EARLY DEVELOPMENTS AND US PATENTS

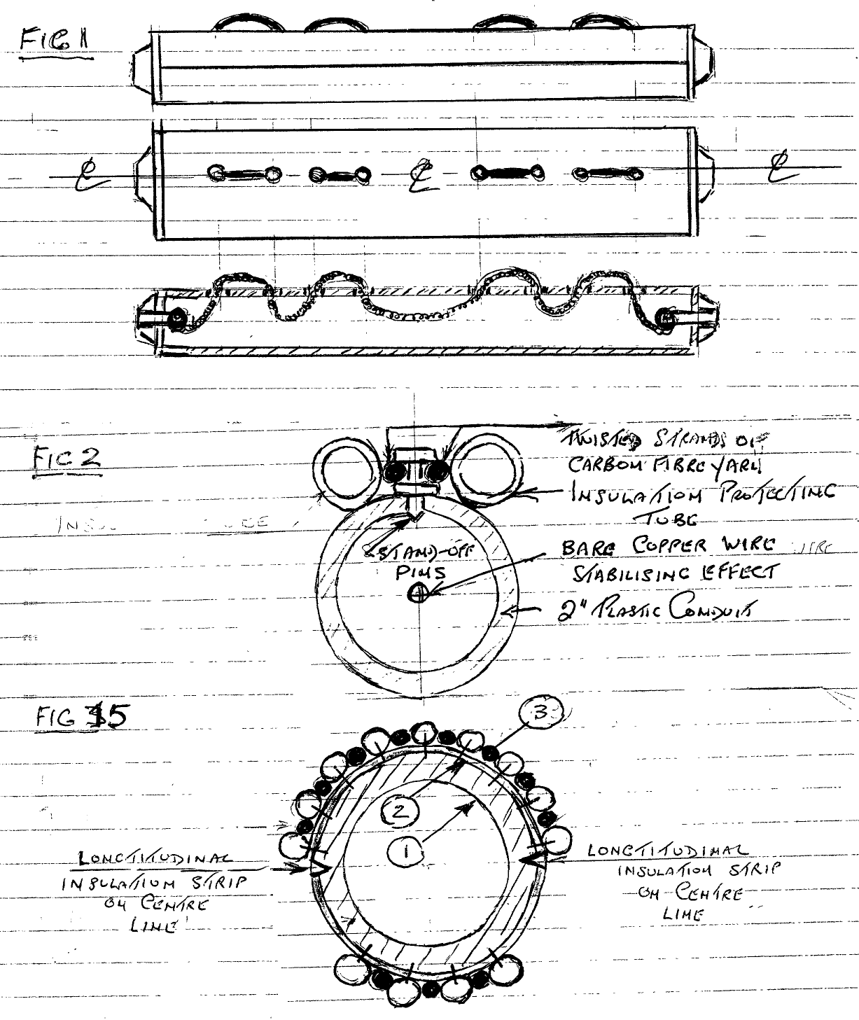

The first Canadian Demonstration “Clean Zone” project after re-engineering the Ion Generator to North American Standards used a combination of the proprietary AMCOR “Bullet” type emitters and the FIG. 1 Bar type of emitter to provide a systemic static distribution of negative air ions within a surrounding permeable T.A.K screen structure as a dust control system designed to ensure minimum contamination of highly sensitive aircraft parts during the final coating process. The arrangement proved successful and was protected by U.S. Pat. No. 5,241,529 issued Aug. 25th 1992 “Dust Precipitation from Air by Negative Ionisation”.

A subsequent installation without screens relying only upon a static system of the bar type of emitters of longer length to control and precipitate cigarette smoke in a fast food outlet was only partially successful. Good results being achieved when the smoke concentration was comparatively light preventing the tainting of food on shelves. But the arrangement was unable to cope with high concentration of cigarette smoking during lunch hours. Indicating a more powerful system was essential with a combination of emitters in both the Passive and Interactive Mode to realise the benefits of the technology operating without the installation of T.A.K screens required by the initial patent “Dust Precipitation from air by Negative Ionisation” and Continuation in Part U.S. Pat. No. 5,296,019 issued Mar. 22^{nd} 1994 and now made obsolete by the current application.

### Initial Breakthrough

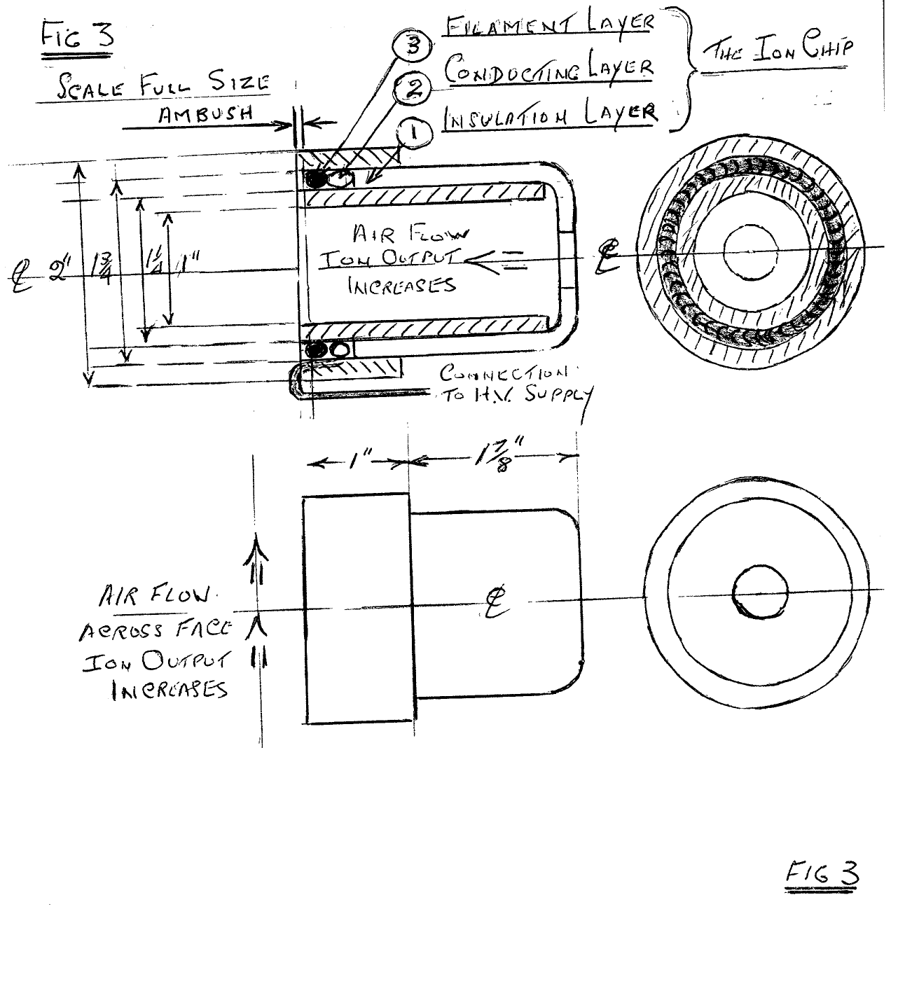

The construction testing and analysis of two models led to the Ion Chip Invention. FIG. 2: The first model demonstrated the stabilising effect of Ion Output when a bare uninsulated wire was run inside a 2″ plastic electrical conduit tube in parallel with an arrangement of a pair of carbon fibre plaited strands mounted on the outer surface of the tube. The strands being supported by a series of small ¼″ diam, grooved stand-off insulation posts and protected by a pair of parallel insulation tubes in contact with the posts. The copper wire and fibre strands being twisted together inside the tube connected to terminal blocks to eliminate the plug-in connectors. An arrangement which was partially illustrated with U.S. Pat. No. 5,296,019 issued Mar. 22^{nd} 1994 and herewith reproduce as FIG. 2 which allowed modified “standard” Ion Generators to supply a series of interconnected emitters located at ceiling height to create a distributed “Shower” of negative ions to cause the precipitation of air borne dust. It was observed that it was essential that the High Voltage insulated wire interconnecting the emitters required to be routed at a higher level than the emitters, including the down droppers, otherwise the static field effect of the supply cable was sufficient to weaken, distort or cut off the emissions altogether, depending upon the vicinity of the supply cable to the emitters.

Also observed was the necessity to change the series interconnection of emitters to avoid the possibility of a high capacitive discharge occurring with any form of faulty supply circuit interruption which entirely nullified the precautions for “Cold Sparking”. The immediate and most economic solution was to have a continuous High Voltage Bus Ring connected to the Ion Generator with a T off connection to each emitter possibly retaining the convenience of a single plug-in adapter. The longer term prospect, subsequently realised by Development was to have an integrated high emissivety source, each with its own Ion Generator, all High Voltage wiring internal to the unit for inherent safety requiring only a standard 110 Volt installation.

The FIG. 2 emitter construction was applied successfully in the Field with a system which removed dust from work in progress described as an “Ion Wash” with low velocity compressed air directed between the pair of carbon fibre plaited strands. With the dust removed being immediately precipitated by an “Ion Shower” created by a series of emitters of the same design located above the workstation. (Refer SPC data—Jaguar Installation) FIG. 16 Wk 39 1992.

The test results confirmed that the effectiveness of the systemic application of negative ionisation could be achieved with the mandatory reduced operating voltage, to comply with ozone limitations and with carbon fibre yarn as the corona forming medium or Ionising Filament. But the arrangement did not fully satisfy the criteria to advance the technology. Also the significance of the “stabilising” wire connected in parallel with the filament to prevent a high capacitive discharge occurring due to a break of the series emitter connections or a break in the fragile carbon fibre yarn for safety reasons was not fully understood until the second model was constructed and tested.

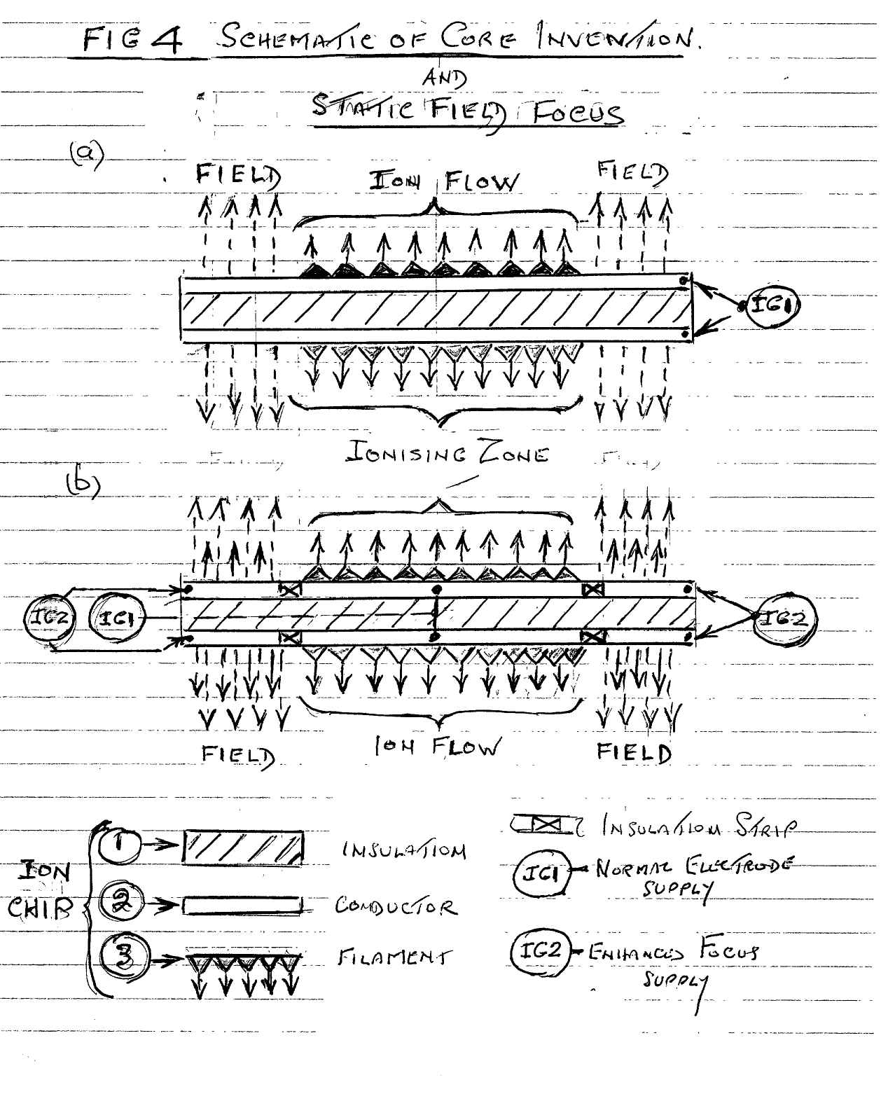

### FIG. 3

The model constructed as FIG. 3 connected to a now standardised Ion Generator was intended as an ionising blow-off device to remove static without subjecting the highly friable weak carbon fibre yarn ionising filament to direct impingement and prospective early deterioration by compressed air. The experiment was highly successful in this respect. Also subsequent analysis determined that the compact construction would overcome a number of problems identified in the criteria of requirements to advance the systemic application of negative Ionisation to improve Indoor Air Quality leading to the concept of the Invention aptly described as the Ion Chip due to the layered robust construction and the inherent design flexibility provided for further development of the systemic technology.

### The Analysis of the FIG. 3 Model Confirmed

That compliance with regulatory requirements of maximum ozone of 0.05 ppm for human occupancy and limited “Cold Sparking” Minimum Ignition Level Fault capabilities for safety of operation would not pose any problem for the continuing development for the systemic application of Negative Ionisation in all but the most extreme hazardous environment.

The construction eliminated prior problems of conductor to carbon fibre yarn connections of reliability and safety.

The construction eliminated prior problems of a fully exposed arrangement of the Carbon Fibre Yarn and provided the maximum possible, semi-enclosed support and protection.

The degree of semi-enclosure of the filament did not materially restrict the multiplier effect of Ion Output with air flow to improve the effectiveness of systemic applications in the Interactive Mode.

The complete surface to surface contact between the carbon fibre yarn and the live conductor ring connected to the High Voltage supply allowed a progressive sequence of replacement thread end electrodes emissions to maintain output levels.

The emissions essentially perpendicular to the exposed top surface yarn had the benefit of a backing and focusing repulsing static field created by the bare un-insulated copper wire to focus and strengthen the emissions.

### Assessment of Model

The model construction specifically resolved the problems of prior designs and illustrated the inherent stable emission capabilities of the Ion Chip composite construction. Additionally the containment, protection, support and ambushing of the carbon fibre strand between the pair of concentric insulation rings, still permitting modulation by external air flows, illustrated the further concept of Operating Modules. Where the filament could be easily replaced to compensate for the inevitable electrode erosion of the ionising process. And the output capabilities of the Composite Emitter Invention, determined by affixing the required number of modules to a common base. The further aspect of enhancing the focus and protection of emissions from distortion by extension of the Composite Base and the creation of repulsing static fields is scientifically apparent. As is the option of a second Higher Voltage for a more effective output and the Intermittent conversion of the system for fumigation to counteract periodic air borne bacteria and pathogenic microbe concentrations.

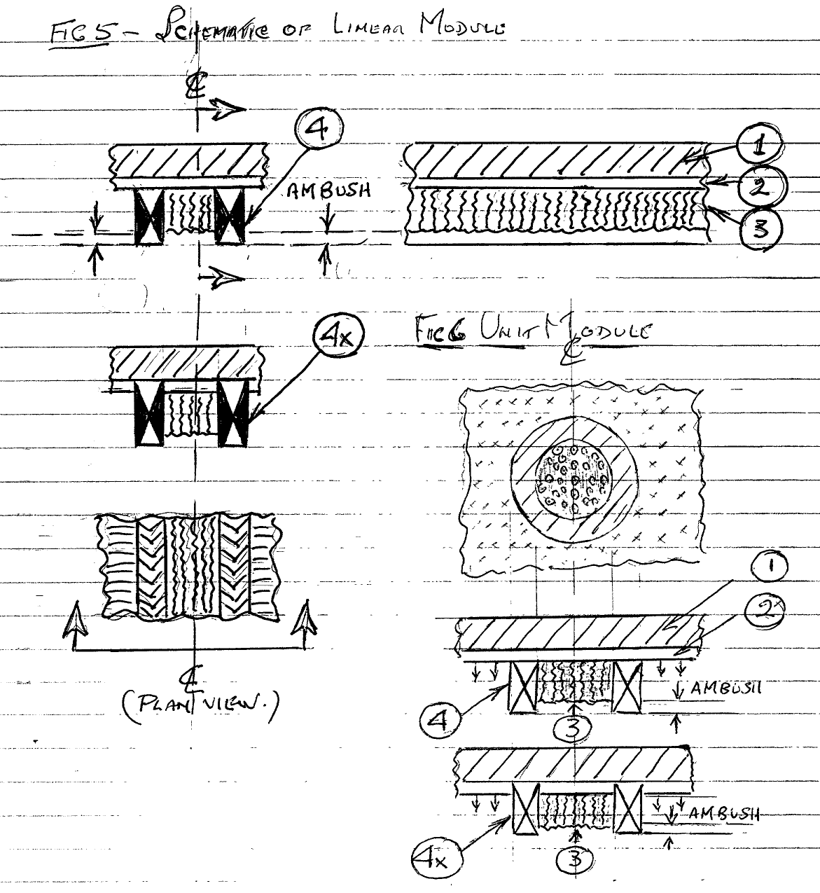

### FIG. 4 Schematic Representation of the Core Invention

1. The Core aspects of the ion Chip invention and embodiments shown double sided for maximum application comprise a basic three layered construction of the composite emitter. All layers of the composite equal in area considered as a laminate. With the intermediate layer item 2 in the form of a high conductivity deposition on the top surface of the insulation base item 1. The combination providing support and protection to the fragile carbon fibre yarn ionising filament item 3 which is also electrically conductive. To complete the laminate composite the ionising filament item 3 is affixed in firm electrical contact with the deposition item 2 with the electrodes on the surface of the filament exposed to the ambient air.

(The alternative use of the conductivity layer as a thin metal support plate is not excluded from the invention but preference has been given to a metallic deposition on the top surface of an insulation base because of design flexibility and economics of manufacture).

2. With an Ion Generator of the appropriate design to ensure minimum ozone entrainment and Minimum ignition Energy “cold sparking” capabilities only “dominant” electrodes of the ionising filament item 3 will emit streams of highly directional gaseous negative air ions essentially perpendicular to the surface of the composite base. The electrodes being “dominant” defined as having the greater sharpness of profile to ionise the air in the first instance and also sufficiently apart from any neighbouring electrode to be free from suppression by stress cone interference. A distance which is a function of the operating voltage, with electrodes operating on the same plane.

3. The conductivity layer 2 connected to the operating High Voltage Generator (IG1) is the Pivotal Feature of the Invention.

Generating a total output measured as the number and type of “active” Negative Air Ions/produced per second/per cubic centimeter/at a distance of one metre from the source and a summation of the operating “dominant” electrodes present within the boundaries of the ionising filament layer.

The charmed electrical surface of the backing layer creating an inboard repulsing field to add focus to the highly directional emissions.

As the initially dominant series of electrodes cease to ionise due to the inevitable erosion, the layer provides an immediate virtually equal short path connection to the operating High Voltage supply to trigger a series of replacements until the source of renewing electrodes is exhausted.

4. An extension of the Composite Base exposed charged surface to surround the ionising carbon fibre filament layer acting as a further repulsing static field to enhance the focus of emissions and prevent their distortion and weakening due to grounded ceiling or other structures in the vicinity of the emitter.

5. To strengthen the emission capabilities of the Invention the Conductivity layer in surface to surface with the filament is separated from that of the surrounding encovered extension by a strip of insulation as shown. Allowing a second Higher Voltage to be applied to strengthen the repulsing static field and providing an enhanced focus to the emissions produced by the filament still connected to the standard Operating Voltage.

6. When considered desirable and appropriate with unoccupied premises the selected Higher Voltage would be applied to the filaments to produce a calculated amount of ozone for the system to act as a fumigator for a prescribed duration when higher than normal bacterial possibly pathogenic microbe air borne contamination is anticipated such as occurs in Hospital and Dental Surgeries, Livestock Barns etc.

### Operating Modules

The next aspect of the Invention is the creating of Operating Modules formed by insulation barriers to subdivide the filament layer and ionising zone as shown in FIG. 4 which contain segregate support, ambush and maintain the filament in full surface to surface electrical contact with the Conductivity Layer so that each Module produces negative air ions in accordance with the Core Invention subject to the electrode forming and erosion characteristics of the particular filament. With preference being given to the use of certain types of carbon fibre yarn which is strongly electrically conductive and when lightly plaited into a strand, has a multiplicity of randomly distributed surface exposed, self renewing thread ends each with the capability under the correct circumstances, to act as ionising electrodes.

In recognition of the inevitable electrode erosion, the design of the Module allow for the simple periodic replacement of the filament. Also for flexibility of operation, the construction would provide the alternative that instead of each filament being connected to the same conductivity layer each could be connected individually to a separate supply. The form of modules, to accommodate various filaments and intended applications include:

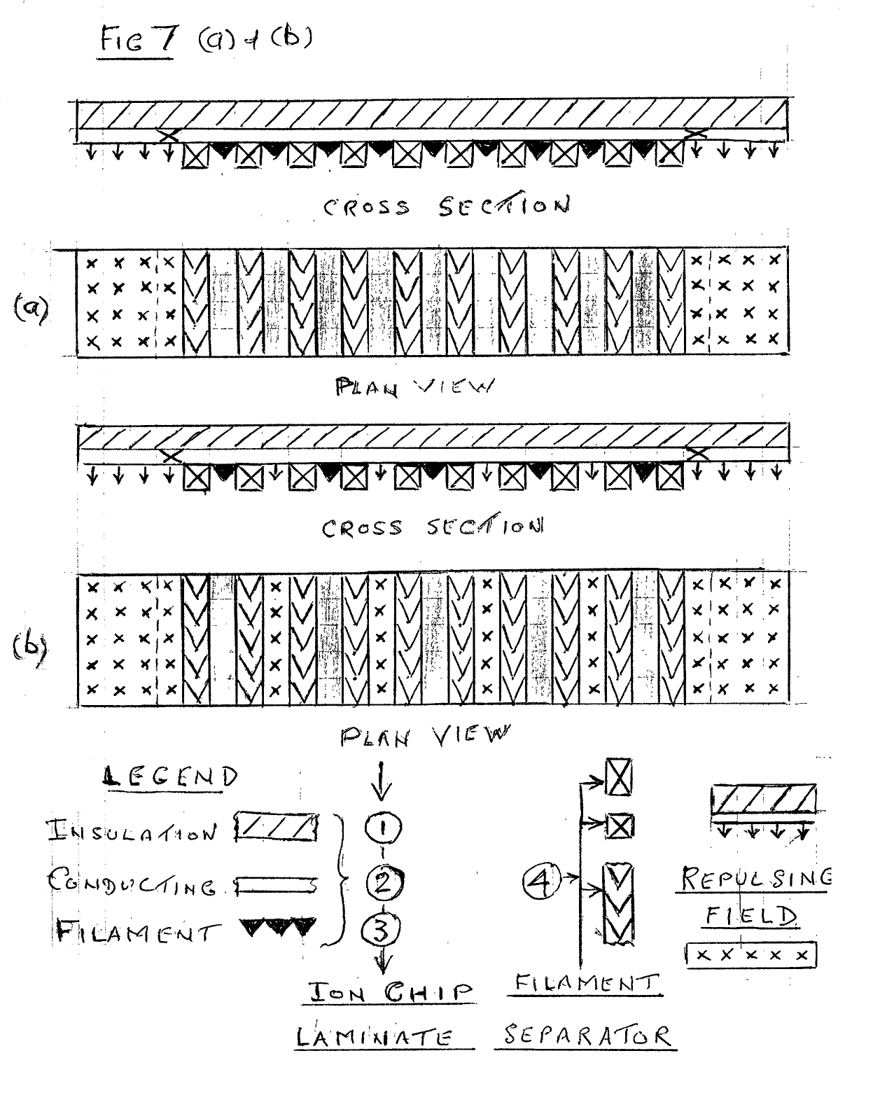

The Linear Module shown in FIG. 5 has a pair of parallel insulation guide strips forming a channel to contain support ambush and maintain the filament in firm contact with the Conductivity Layer the filament comprising Carbon Fibre Yarn in strand form, alone or in combination with ionising needles or ionising needle alone or other form of corona forming electrodes.

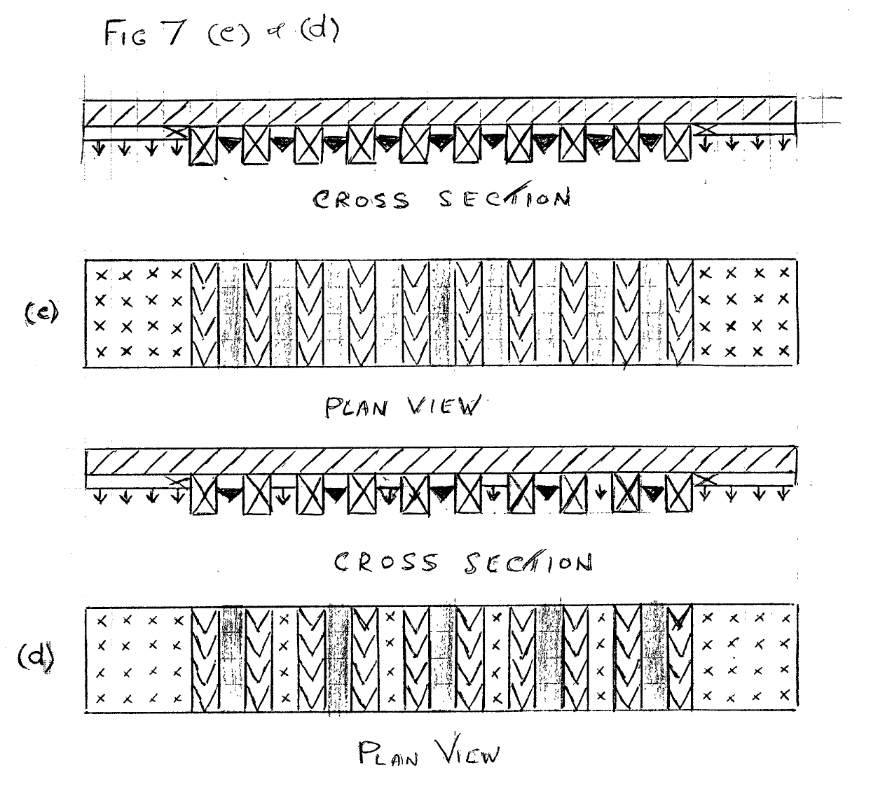

The Unit Module shown in FIG. 6 has an insulation tube to contain, support, ambush and maintain the filament in firm contact with the Conductivity Layer. The filament comprising carbon fibre yarn in the form of short brush stubs, alone or in combination with ionising needles or ionising needle alone or other form of corona forming electrodes.

Modules can now be assembled on a common base to provide a Composite Emitter with the output specification required for the particular application.

In terms of the volume and number of small active negative air ions produced per second, per cubic centimetre as measured one metre from source.

A level of output that notwithstanding the fragility of the filaments which can be maintained by simple planned cleaning procedures of completely static equipment, made possible by the robust construction of the Module design.

The Core Invention combined with the Operating Modules requiring only nominal cost addition has successfully overcome problems of an operational and maintenance nature of prior designs with a major technological payback with the Systemic Application of Negative Ionisation to improve Indoor Air Quality not only in the Passive Mode but particularly in the hitherto under-utilised Interactive Mode.

### Two Tier Supply System

The systemic performance can be substantially improved by providing a second Higher Voltage supply to be connected only to the extensions of the composite base to further enhance the focus of emissions and their protection from grounded structure, acting as a reflector to provide a degree of acceleration and energy to the ions.

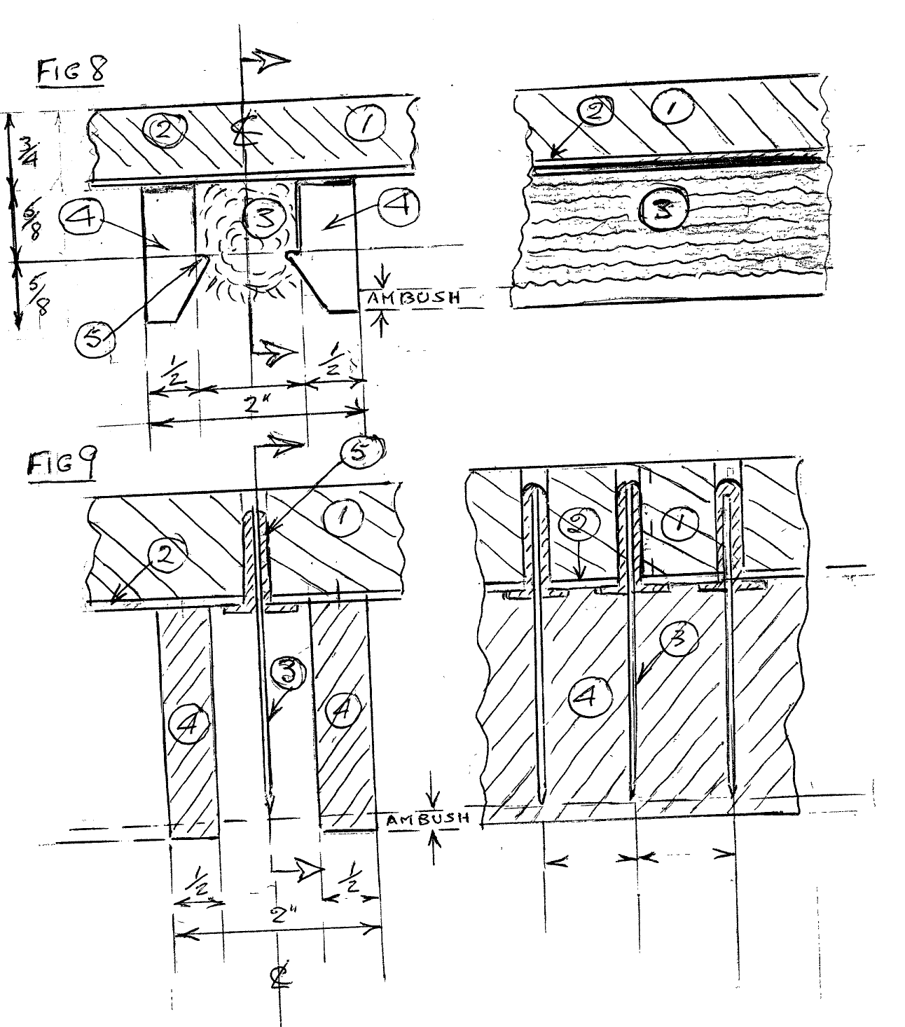

### FIG. 7 Emitter Output Profiles—Linear Modules

FIG. 7(a) This Composite Emitter Output Profile shown in Cross Section and Plan is a group of Linear Modules assembled with the minimum spacing required for the insulation to separate the filaments. With an extension of the composite base either side of the group. With the Conductivity Layer connected to the standard regulated Ion Generator. A concentration of emissions will result focused by the repulsing static field both in strength as a function of the operating high voltage. With the insulation strip insert to separate the Conductivity Layer as shown. A second higher voltage connected only to the composite base extensions will enhance the focus of emissions acting essentially as a reflector with a proportionally higher strength repulsing static field.

FIG. 7(b) This profile has the Linear Modules assembled spaced apart, with an extension of the composite base either side as before with the Conductivity Layer connected to the standard regulated Ion Generator a distribution of emissions will result, each emission individually as well as the group of emissions focused by the repulsing static field both in strength as a function of the Operating High Voltage. With the insulation strip insert to separate the Conductivity Layer as shown a second Higher Voltage connected only to the Composite Base extension will enhance the focus of emissions acting essentially as a reflector with a proportionally higher strength repulsing static field.

FIG. 7(c) This profile is a variation of (a) with a concentration of emissions but allows each module filament to be connected to the standard Ion Generator on a selective basis to vary the output level of the Composite Emitter on a pre-programmed basis.

FIG. 7(d) This profile is a variation of (b), providing the same facility as (c) to vary the output level of the Composite Emitter on a pre-programmed basis.

### Unit Modules

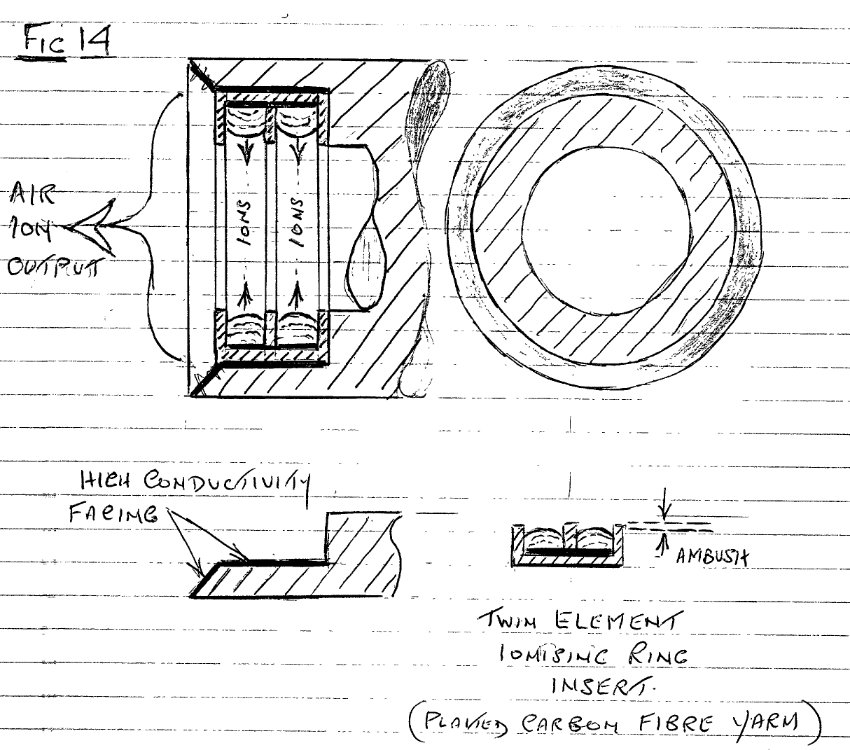

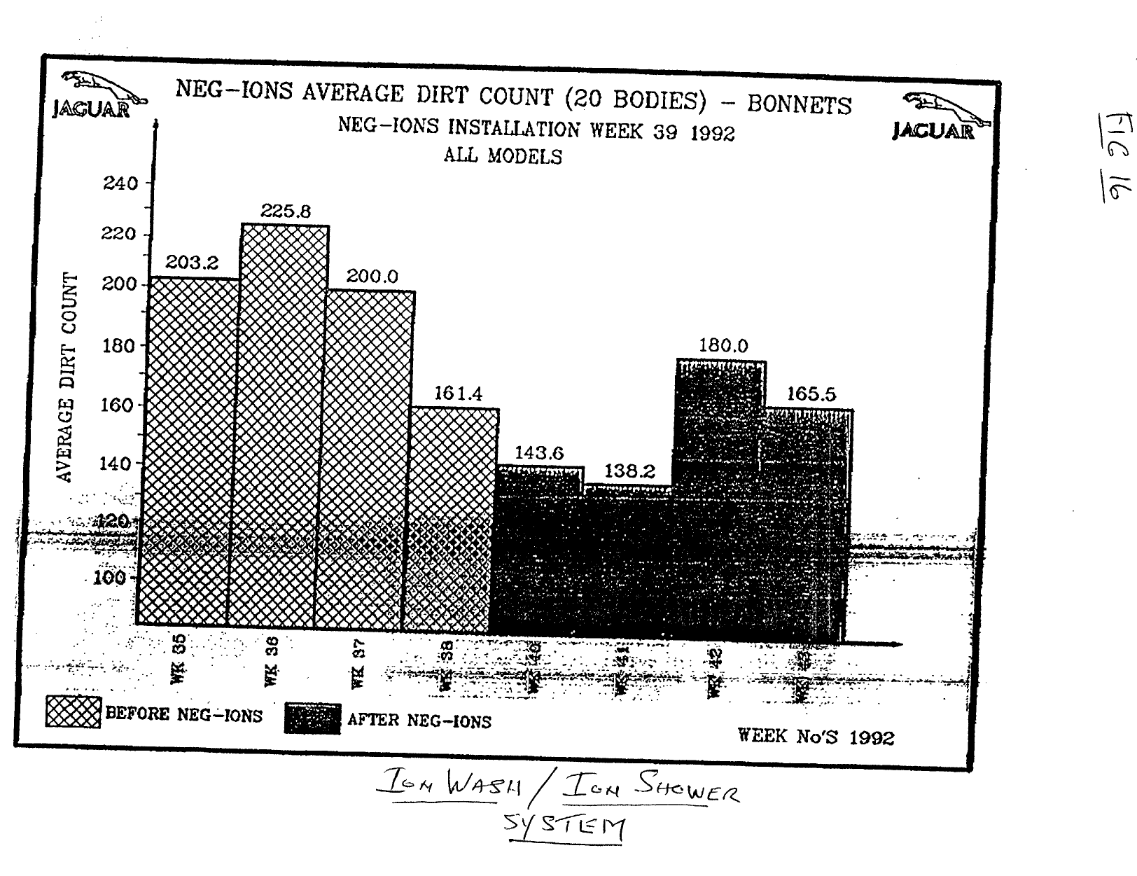

Unit Modules can be arranged in a similar manner as Linear Modules to obtain the desired output of a Composite Emitter as previously described in FIG. 7. With the added advantage that the Unit Module not only allows for filament replacement. But can be manufactured as a throwaway item comparable to a light bulb. As shown in FIG. 12 and FIG. 13

### Fumigating System

With the two tier system in place to obtain the benefits of stronger focusing as described it is a simple matter with all profiles to connect the filaments to the secondary supply to produce a pre selected amount of ozone on an intermittent basis to coincide with times when high concentrations of air borne bacteria or pathogenic microbes may be anticipated such as occurs in Medical and Dental institution and Animal Rearing Barns.

### Composite Emitter Modules

A further aspect of the Invention and the use of Operating Modules to provide a Composite Emitter of a desired output specification is that the Composite Emitter itself is considered as a module or element to be incorporated as one of a number to be assembled as part of a self contained Ionising Fixture providing a compounded integrated output of negative air ion emission for any Mode of Operation.

### Bar Type of Composite Emitter Module

The Bar Type of Composite Emitter Module is rectangular in shape of sufficient thickness to provide adequate electrical separation between the two faces of the Bar. Each surface having any of the output profiles as illustrated in FIG. 7 distributed LongitudinallY or Traversely to provide the desired output. With only one side connected to the Operating High Voltage supplies to extend operating life. With the prospect that after the reserve side is depleted the Composite Emitter would be replaced similar to a fluorescent tube used broadside for the Passive Mode and on end for the Interactive Mode minimising the disturbance to existing ventilation air flows.

### Tube Module

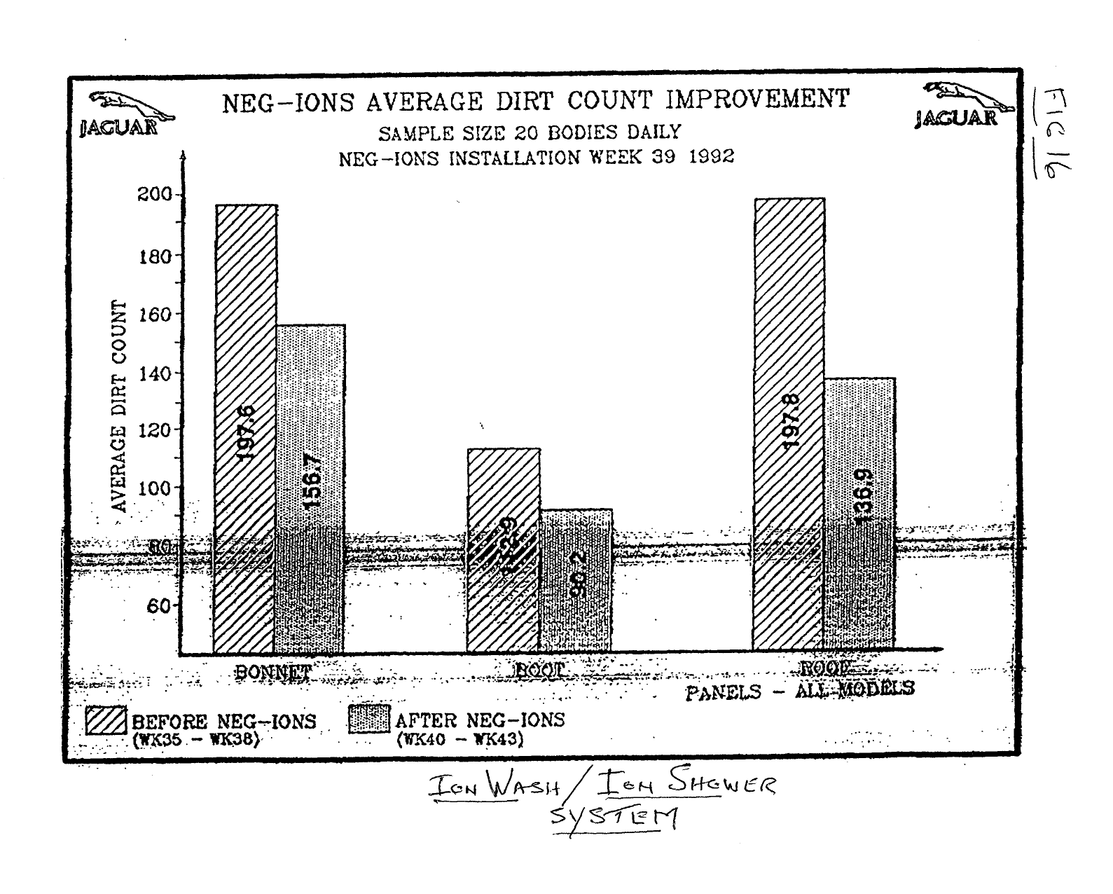

The tube Composite Emitter Module is illustrated in FIG. 15 with a longitudinal output profile in this instance and serves to show the advancement and improved design of emitter in the three stages of Development on a single sheet.

### FIG. 8

This figure shows the cross section of a module with carbon fibre yarn as a continuous plaited strand ionising filament item 3. Which is assembled and affixed to the top conducting layer of the composite insulation/conducting base items 1 and 2 to form the Ion Chip.

The first step of assembly is to pin the pair of insulation guide strips item 4 which has conducting layers on the base and sides as shown onto the composite base, the requisite distance apart to form a channel to receive and ambush the ionising filament item 3, The channel following the contours of the composite base and the length of the filament required.

The next step is to press the filament firmly into the channel thus formed, which will make contact with the conducting layer item 2 and the conducting layers on the guide strips item 4 and be securely retained by the ledges item 5 formed, on item 4. The ledges also assisting the spreading of the surface thread electrodes exposed to the ambient air. With the ionising layer item 2 connected to a high voltage Ion Generator a constant emission of air ions will take place by self-renewing electrodes of the carbon fibre yarn.

The construction provides the option of securing pins for to assist the exposure of surface thread ends. Or the addition of conventional needle electrodes to extend operating life, and monitor wear of the yarn ionising filament.

Filaments are easily replaced which can be done in prepared short lengths.

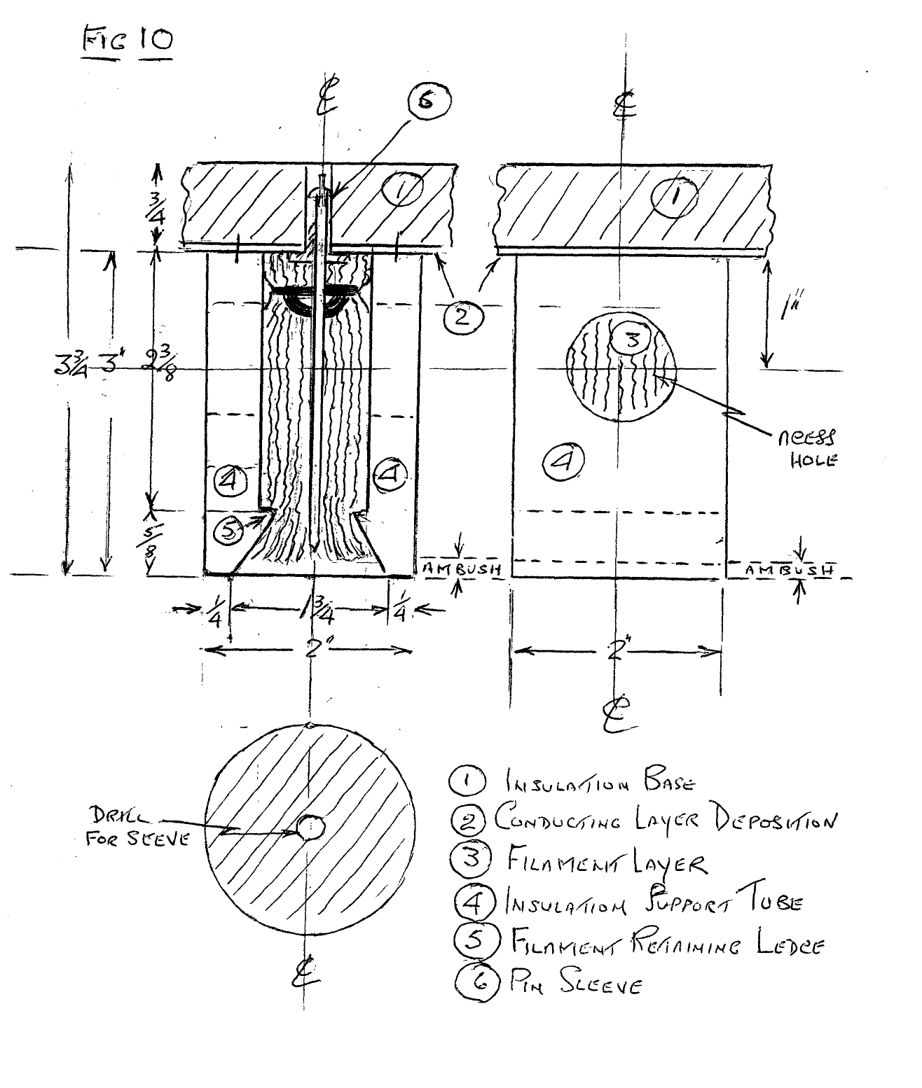

### FIG. 9

This figure shows the cross section of a module with a continual line of conventional needle electrodes as the ionising layer item 3 assembled on the composite insulation/conducting base items 1 and 2 to complete the Ion Chip. A simpler design of separating, ambushing guides item 4 will accommodate the length of the needles as the retaining ledge is not required.

The first step for assembly is to pin the pair of insulation guide strips item 4 onto the composite base, the requisite distance apart to form a channel to receive and ambush the series of needle electrodes item 3. To follow the contours of the composite base.

The next step is to drill holes in the composite base plate to accommodate a spring-loaded holder for each needle item 5.

With the ionising layer item 2 connected to a high voltage Ion Generator the emission of air ions will take place for the working life of the ionising filament needles which can then be replaced.

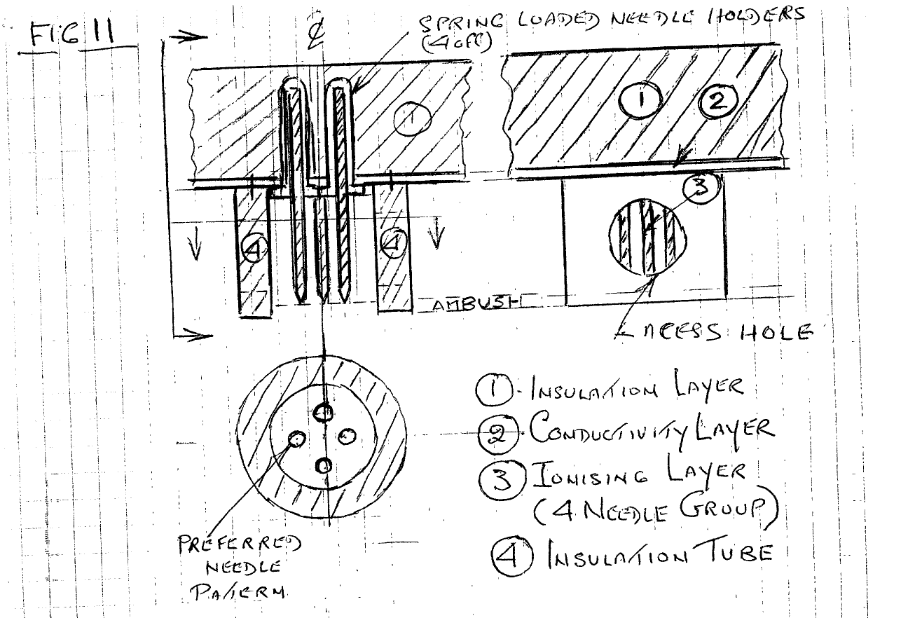

### FIG. 10

This figure shows the cross section of a module using plaited carbon fibre yarn, cross cut to form short brush stub ends as the ionising filament with items 1, 2 and 3 comprising the Ion Chip.

The method of assembly is to have the short brush end stub pre-assembled for insertion into the insulation tube item 4.

The operating end of the tube exposed to the ambient air is flared and has a retaining rim ensure that the ionising filament is kept in contact with the conducting layer 2 until withdrawal and replacement.

A hole is drilled through the composite base and fitted with a spring-loaded retaining sleeve item 6 at the required location on the base. The tube item 4 is then located centrally and fixed in position by double ended pins.

The method of filament assembly is for the short brush stub ends to be banded with fine copper wire around a central pin. With a small spring cup washer attached to the pin behind the banding to facilitate the filament being inserted into the tube which is then retained in full contact with the conductivity layer firstLY by spring loaded sleeve assisted by the rim item 5 on the tube item 4 which also serves to spread the thread ends of the filament.

With the conducting layer item 2 connected to High Voltage Ion Generator a continuous stream of air ions will be emitted as successive carbon fibre thread end electrodes become dominant to form corona. A process which will continue until such time as the life of the ionising filament is exhausted due to the wear down in operation of the thread end carbon fibre electrodes at which time the filament can be withdraw, and replaced.

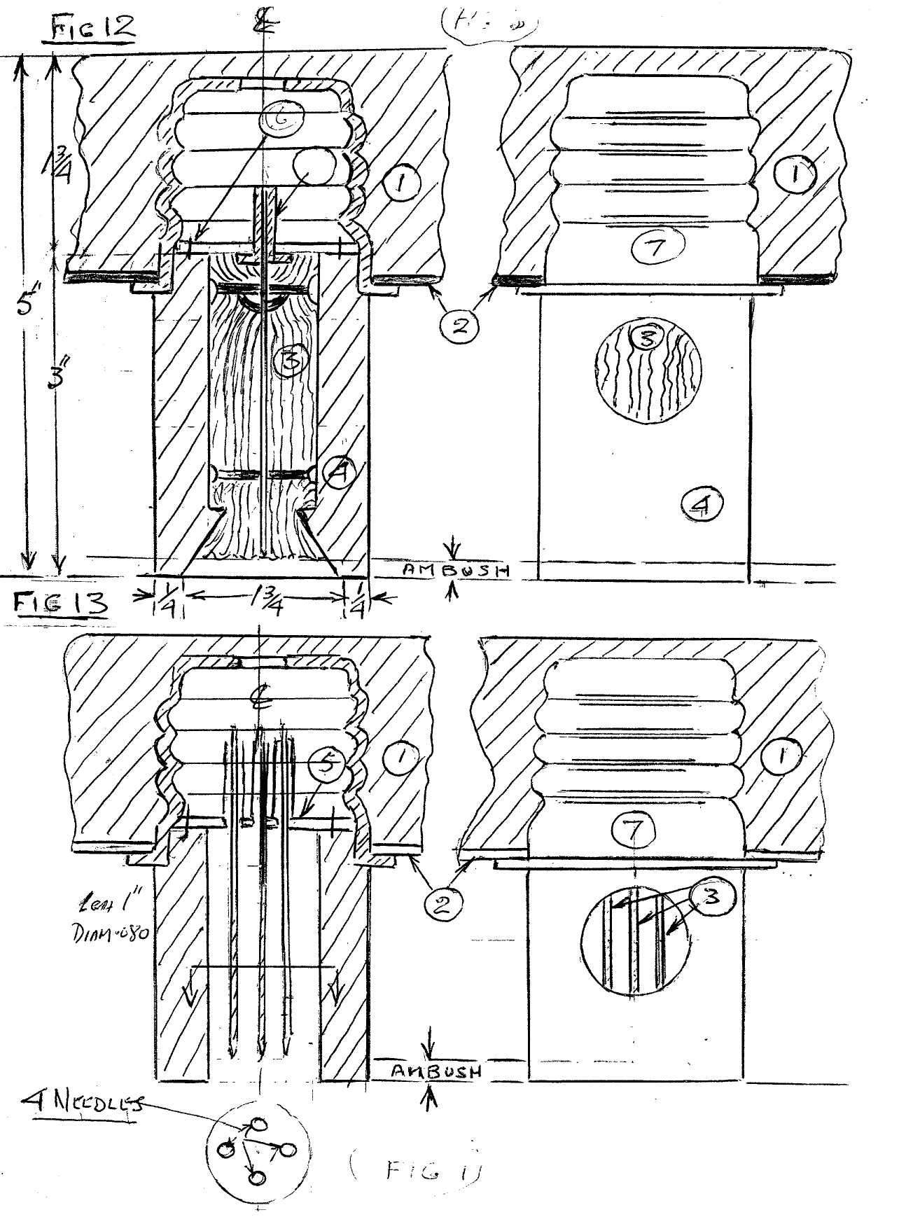

### FIG. 11

This figure shows the cross section of a module to use a group of four closely spaced conventional needle electrodes as the ionising filament item 3 assembled with the composite insulation/conducting layer base items 1 and 2 comprising the Ion Chip.

An insulation tube item 4 acts to support protect and isolate the filament item 3 with the length required to ambush the tip of the ionising electrodes.

The composite base items 1 and 2 is drilled to accommodate the insertion of four spring loaded needle holders tightly secured to the base with an interference fit.

With the conducting layer connected to the High Voltage Ion Generator and the needle electrodes inserted, air ions will be constantly produced as successive electrodes take over until tip erosion takes place. A simple inexpensive replacement of the needles will maintain performance and restore the calculated ion output from the module.

### FIG. 12

This figure shows the construction of a convenient throw away Ion Bulb alternative to the replacement of the ionising filaments to maintain operating performance as simple as changing a small light bulb.

With the ionising filament of plaited carbon fibre yarn crosscut into short brush stubs the only change from FIG. 10 is the addition of a small metal disc item 6 to which a centre sleeve is attached pinned to the non operating end of the tube item 4.

With the preparation of the filament as before and secured within the tube item 4 as detailed in FIG. 10 except that the locating needle or pin can be simply permanently crimped as withdrawal and change feature is not required.

The final step is for the complete assembly to be attached to a type of screw lamp holder item 7 and the composite insulation-conducting base fitted with a female receptor.

### FIG. 13

This figure shows the construction of a convenient throw away Ion Bulb alternative to maintain operating performance as simple as changing a light bulb. With a group of conventional needle electrodes as the ionising filament all that is required is to change the spring loaded electrode holder to one which has sleeves which are crimped to attach the needle electrodes firmly and permanently to the assembly which is then fitted with the end cap item 7 to complete the ion Bulb.

With the conducting layer 2 connected to a high voltage Ion Generator supply in this case by screwing the Ion Bulb into a female receptor fitted to the composite base air ions will be constantly produced as successive needle electrodes take over until output falls off with the sharp point deterioration of the needle electrodes.

A quick simple replacement of the Ion Bulb will maintain performance of the system similar to a lamp change of a lighting installation.

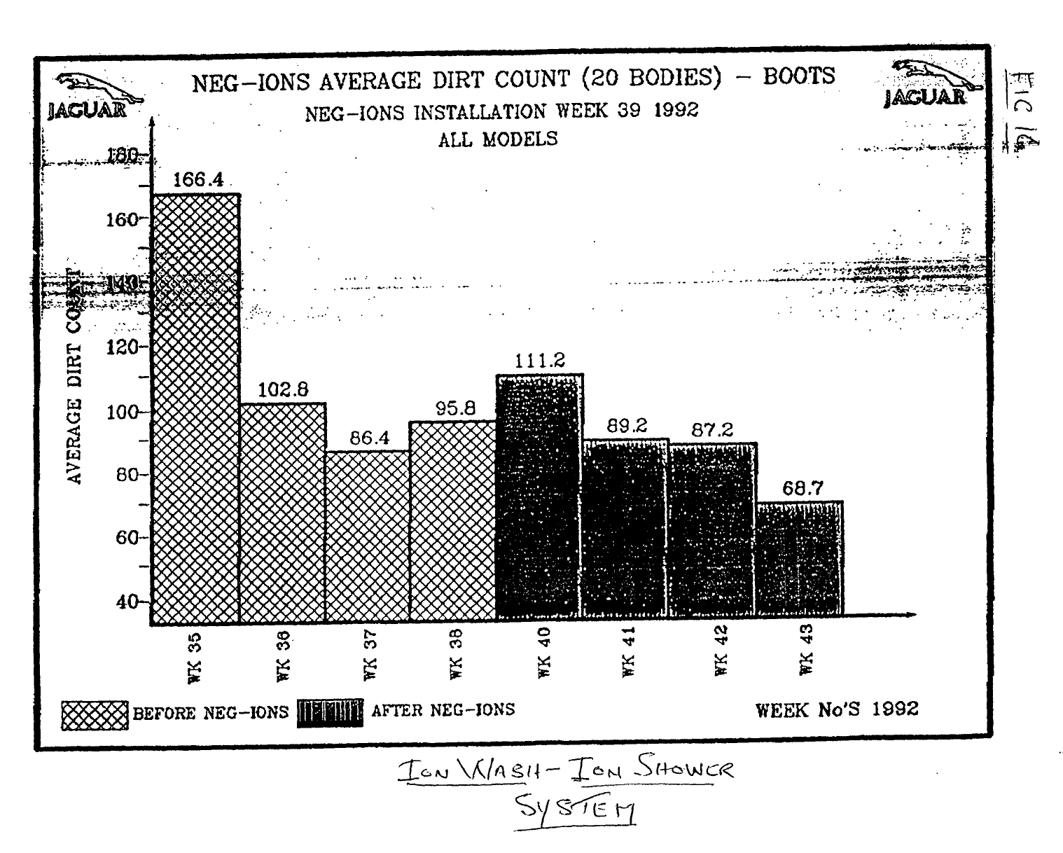

### FIG. 14

This figure shows how ionising rings can be used for a low velocity blow off ionising gum or fitted to a ventilation tube to inject streams of negative ions into a ventilation system.

Since various adaptations and modifications can be made in my Ion Chip Composite Emitter Invention and many apparently widely different embodiments of same made within the spirit and scope of the claims without departing from such scope it is intended that all matters contained in the accompanying specification shall be interpreted as illustrative only and not in a limiting sense.

The Invention of a unique laminated highly flexible “Ion Chip” construction design of Composite Emitter to produce gaseous negative air ions when connected to an electronically generated uni-polar High Voltage operating supply of limited threshold valve in the order of 7.0 KV which guarantees a restricted ozone entrainment well within the EDA recommendation of 50 parts per billion and limited short circuit capacity, to ensure only Minimum Ignition Energy (MIE) “cold sparking” under fault, to allow the operation of a distributed interconnected system of such emitters to act “passively” with the ambient air. And “interact” dynamically with the existing ventilation or other air flows within enclosed occupied and prospectively hazardous environments. All systems installed in full Compliance with Safety and Environmental Regulatory requirements, to improve Indoor Air Quality by the control and earliest precipitation of air borne contaminants and remedy deficiencies in Electrical Air Quality of Neg/Pos air ion imbalance in a unique highly cost effective manner. The combined aspects of the Invention providing distinct competitive operating advantages to optimise the Application and Maintenance of Systemic Negative Ionisation Technology in the Workplace to obtain the benefits of increased Productivity, assured Product Quality and higher standards of Health and Safety.

I claim

1. The core aspect of the “Ion Chip” Invention and embodiments, consists of a basic three layered laminate construction comprising:
Firstly an insulation layer with the characteristics of high dialectic strength to withstand the operating voltage, without breakdown or tracking in Indoor Areas.
An intermediate layer of high electrical conductivity in the form of a metallic deposition on the top surface on the insulation base, viable due to the minuscule operating current requirements and selected because of design flexibility and economics of manufacture:
Thirdly a fragile ionising layer of electrically conductive carbon fibre yarn characteristically having a multiplicity of surface exposed thread ends known to have the capability to act as ionising electrodes, when the yarn is connected to a High Voltage source.

2. A physical aspect of the Invention is that support and protection is given to the fragile carbon fibre ionising filament, replacing prior designs of easily damaged suspended loops and strings of the yarn. While electrically the full surface to surface contact eliminates difficulties experienced with yarn end connections.

3. Operationally the conductivity layer is pivotal to the Invention.
By initially triggering the “dominant” electrodes of the filament to emit highly directional streams of negative ions essentially perpendicular to the conductive surface on top of the insulation base.
As the initial group of “dominant” electrodes cease to operate due to erosion, replacement “dominant” electrodes, having the requisite sharpness of profile and sufficiently apart from any neighbour to be free from stress cone plasma interference, will take over automatically and sequentially due to being connected to the operating supply by the conductivity layer until the source of prospective electrodes exposed upon the surface of the ionising filament layer is exhausted.
The electrically High Voltage charged surface of the layer also creating a backing repulsing static field to add focus to the highly directional emissions as sequentially produced.

4. The Invention for certain applications has the alternative that a suitably bottom insulated thin metal plate of high conductivity material can act as the support member of the Ionising Filament with similar ionising capabilities.

5. The Invention is not restricted to the use of carbon fibre yarn as the ionising filament and similar benefits of protection and performance will be obtained with alternative filaments either alone or in combination with the yarn as a composite filament.

6. The Invention for reasons of Hygiene, Temperature or Aesthetics can employ ceramic materials for construction with specialised operating filaments for Medical Applications.

7. The Invention with a suitable base material can combine the deposition of conductivity and ionising medium as a source of surface exposed corona stressing electrodes to produce negative air ion emissions as previously claimed.
A further aspect I claim for the Invention is the addition of insulation separating barriers to form Operating Modules to contain, support, ambush and maintain each Ionising Filament in full electrical contact with the intermediate Conductivity Layer. The modules being assembled with the number type and spacing of filaments to provide the desired emission characteristics of the Composite Emitter.
In terms of the volume and number of small active negative air ions produced per second, per cubic centimetre measured one metre from source.

8. A common feature of all Operating Modules is some form of insulation separating barrier to contain, support, protect and ambush the Ionising Filament and outlines the boundary of the module.

9. All modules have the fragile ionising filaments semi-enclosed to the maximum practical extent for the cleaning and in-situ maintenance of the emitters to be done without the prospect of damage. Without detracting from the capability to increase ion output when modulated by ventilation or other external air flows directed either through the body or across the face of the Composite Emitter.

10. The construction of all Modules allows for the inevitable wear of the ionising process by the replacement of the filament as a simple economic maintenance procedure, or a more convenient replacement of the entire module or the replacement of the entire Composite Emitter to maintain the Operating Performance of the systemic installation

11. The boundaries of a Linear Module taking the form of a pair of suitably spaced parallel insulation guide strips to form a channel for a continuous plaited strand or woven strip of carbon fibre yarn. The surface exposed thread ends acting as ionising electrodes either alone or in combination with conventional needle electrodes which can assist both emission and assembly.

12. The boundaries of a Unit Module taking the form of an insulation tube of the required Inside Diameter to both isolate and support a short upended crosscut stub of plaited carbon fibre yarn. The brush thread endings acting as ionising electrodes either alone or in combination with conventional needle electrodes to assist both emission and assembly.

13. A double sided Composite Emitter construction will double the operating life. One side, unconnected in reserve to be brought into action as required.
A further aspect I claim for the Invention relates to the extended use of the repulsing static field created by the charged state of the exposed surface of the conductivity layer to enhance the focus of the inherently highly directional emissions and also to protect all emissions from distortion or weakening due to grounded structures in the vicinity of the composite emitter essentially acting as an “ion Reflector”

14. With the composite emitters required for the “Passive Mode of Operation” and consequently mounted at or near ceiling height, modules are affixed to composite base plate and grouped together with minimum spacing to provide an area of high density of emissions. Protected from weakening or distortion by grounded structures in the vicinity of the emitter by an extension of the base plate to surround and encompass the total group of modules.

15. Optionally modules for the “Passive Mode” can be affixed a certain distance apart so that the intervening spaces of the base plate exposed charged surface will enhance the focus of the individual emissions in addition to the extension used to protect the emissions from distortion.

16. With emitters required for the “Interactive Mode” of Operation the Composite Emitters must be part of an open structure to allow the ventilation air to pass through and across the faces of the modules to obtain the air ion multiplying effect while offering the minimum acceptable obstruction and resistance to the designed air flow and distribution. In this instance a separate encompassing extension fixture can be used to protect the group of emissions from grounded structures.

17. The Invention does not exclude that in preference to a retro-fit installation to interact with Ventilation air flows the modules can be made integral with the incoming air diffusers and distribution fixtures of a conventional HVAC installation.
A further operating aspect I claim for the Invention relates to the use of a secondary High Voltage operating supply to optimise the systemic application of Negative Ionisation. To attain and maintain within the selected environment a plasma field condition approaching natural outside air.

18. This requires the selection of an additional High Voltage supply of a threshold value greater than the normal operating supply. With the modules normally connected to the restricted operating supply to produce emissions in accordance with the Core Invention. With the extensions acting to enhance the focus of individual modules and/or protect emissions from distortion and weakening due to grounded structure are connected to the higher voltage to enhance the focus and impart energy to the streams of negative air ions.

19. When desirable permissible and appropriate during unoccupied periods of the environment undergoing treatment the modules can be temporarily switched to the higher voltage to emit a calculated entrainment of ozone with the negative air ions to act as mild but powerful fumigating system for applications where air borne pathogenic microbes may be part of the air quality problem, such as known to occur in Medical Institutions, Food Preparation, Livestock Barns, Aircraft and other Transport, where this form of air borne contamination is known to be particularly troublesome.

20. I further claim the development of a self contained “Ionising Fixture” combining all the aspects of the invention. The fixture comprising an assembly of a number of high output double sided replaceable Composite Emitters to provide an integrated compounded source of Negative Air Ion emissions, further focused and protected from distortion as a group by separate extensions of the conductivity layer. With all High Voltage wiring made internal to the Fixture installations a standard 110 Volt distribution suitable for Industrial, Commercial, Institutional and Domestic Establishments.
